(19) United States
(12) Patent Application Publication
(10) Pub. No.: US 2017/0155416 A1
(43) Pub. Date: Jun. 1, 2017

(54) PROTECTING APPARATUS FOR ELECTRONIC DEVICE

(71) Applicant: HON HAI PRECISION INDUSTRY CO., LTD., New Taipei (TW)

(72) Inventors: HAN-PIN LIU, New Taipei (TW); CHIEH-YU LEE, New Taipei (TW)

(21) Appl. No.: 14/974,154

(22) Filed: Dec. 18, 2015

(30) Foreign Application Priority Data
Nov. 26, 2015 (CN) 201510843874.8

(51) Int. Cl. H04B 1/3888

(52) U.S. Cl. CPC H04B 1/3888

(57) ABSTRACT

A protecting apparatus for an electronic device includes a main body fixed to the electronic device, a buffering assembly arranged on an outer surface of the main body, an accelerometer, a controller, an electromagnetic assembly configured to adhere the buffering assembly to the main body, and a power supply configured to provide power to the electromagnetic assembly. The buffering assembly includes an elastic element and a buffering element. The buffering element is coupled to the main body through the elastic element. The electromagnetic assembly includes a first electromagnetic element arranged on the main body and a second electromagnetic element arranged on the buffering element. The power supply provides power to the electromagnetic assembly to cause the buffering element to adhere to the main body. The controller controls the power supply to stop supplying power to the electromagnetic apparatus when the acceleration of the main body exceeds a threshold value.

### FIELD

The subject matter herein generally relates to an apparatus for protecting an electronic device when the electronic device is dropped.

### BACKGROUND

Generally, an electronic device may be protected by a cover or a protective case to minimize damage when the electronic device is dropped.

### BRIEF DESCRIPTION OF THE DRAWINGS

Implementations of the present technology will now be described, by way of example only, with reference to the attached figures.

FIG. 1 is a diagrammatic view of an embodiment of an electronic device including a protecting apparatus.

FIG. 2 is a block diagram of the electronic device.

FIG. 3 is a cross-sectional view taken along line of FIG. 1.

FIG. 4 is a cross-sectional view taken along line IV-IV of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

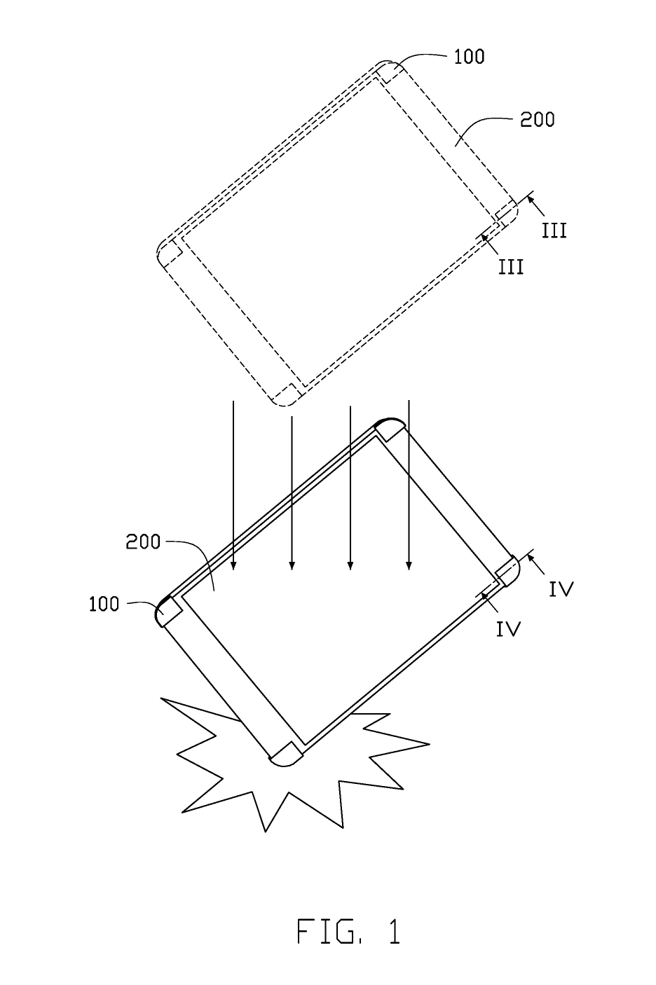

FIG. 1 illustrates an embodiment of an electronic device 200 including a protecting apparatus 100. The protecting apparatus 100 is used to cushion the electronic device 200 against impact when the electronic device 200 is dropped.

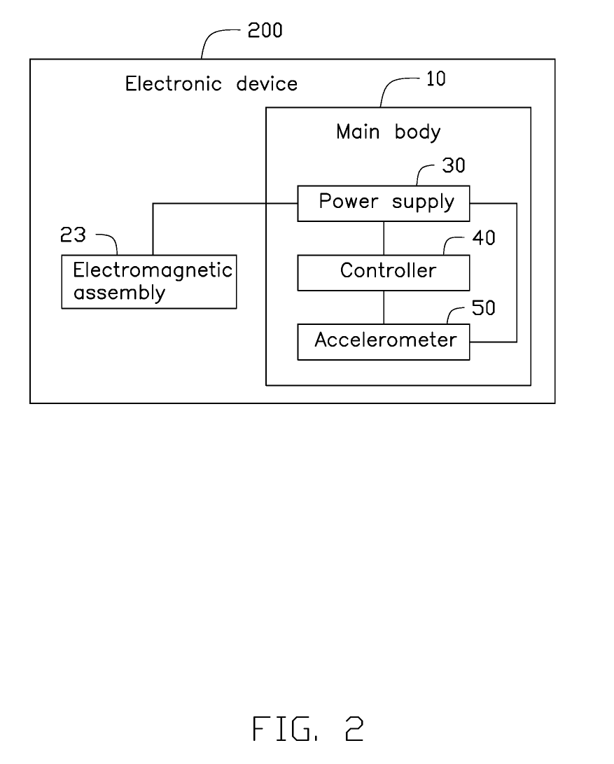

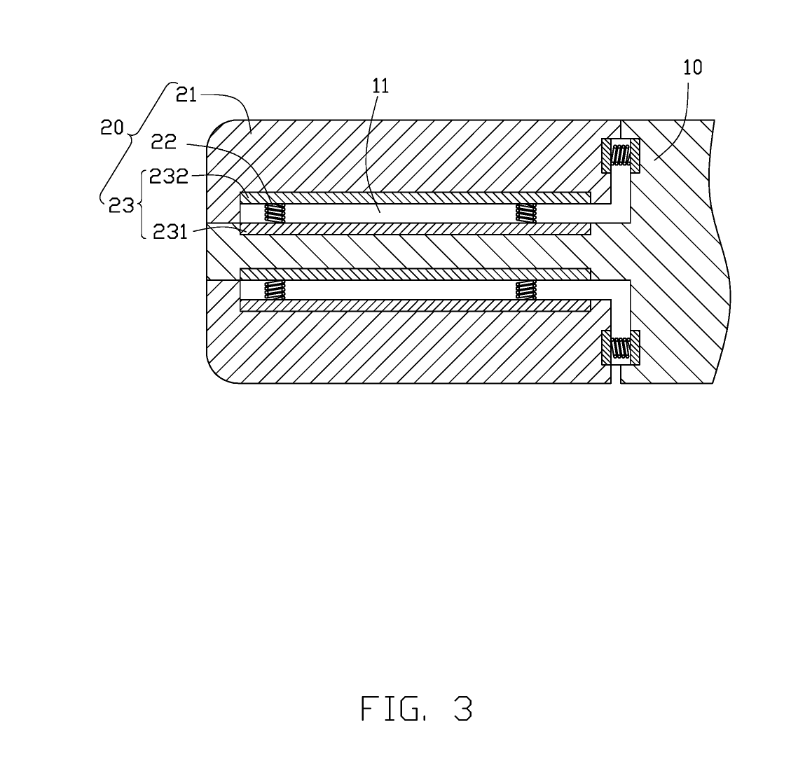

As illustrated in FIG. 2 and FIG. 3, the protecting apparatus can include a main body 10, a buffering assembly 20, a power supply 30, a controller 40, and an accelerometer 50. In another embodiment, the main body 10 is the body of the electronic device 200. The buffering assembly 20 can be arranged on an outer surface of the main body 10. The power supply 30, the controller 40, and the accelerometer 50 can be arranged inside the main body 10.

In at least one embodiment, the main body 10 can be fixed to a body of the electronic device 200 by an adhesive. In another embodiment, the main body 10 can be a protective case of the electronic device 200. In the illustrated embodiment, the main body 10 is the body of the electronic device 200, and the power supply 30, the controller 40, and the accelerometer 50 are received inside the electronic device 200.

The power supply 30 can provide power to the controller 40, the accelerometer 50, and other electronic components of the electronic device 200. The accelerometer 50 can detect an acceleration of the main body 10.

As illustrated in FIG. 3, the buffering assembly 20 can include at least one buffering element 21, at least one corresponding elastic element 22, and at least one corresponding electromagnetic assembly 23. One end of the elastic element 22 can be coupled to the main body 10, and another end of the elastic element 22 can be coupled to the buffering element 21. Thus, the buffering element 21 is coupled to the main body 10 through the elastic element 22. In at least one embodiment, the elastic element can be glued or soldered to the main body 10 and the buffering element 21.

The main body 10 can define at least one cutout 11 corresponding to the at least one buffering assembly 20. The buffering element 21 can be received in the cutout 11. In at least one embodiment, each corner of the electronic device can define a cutout 11, and a corresponding buffering assembly 20 can be received in each cutout 11.

The power supply 30 can be electrically coupled to the electromagnetic assembly 23 to provide power to the electromagnetic assembly 23. The electromagnetic assembly 23 can include a first electromagnetic element 231 and a second electromagnetic element 232. The first electromagnetic element 231 can be arranged on the main body 10, and the second electromagnetic element 232 can be arranged on the buffering element 21. In at least one embodiment, the first electromagnetic element 231 and the second electromagnetic element 232 are electromagnets. In another embodiment, one of the first electromagnetic element 231 and the second electromagnetic element 232 is an electromagnet while the other one of the first electromagnetic element 231 and the second electromagnetic element 232 is made of material, such as iron, cobalt, or nickel, which can be attracted by the electromagnet.

In an initial state of the protecting apparatus, the power supply 30 provides power to the electromagnetic assembly 23 to cause the first electromagnetic element 231 and the second electromagnetic element 232 to be attracted to each other, thereby causing the elastic element 22 to be in a compressed state. The elastic element 22 in the compressed state holds the buffering element 21 in the cutout 11.

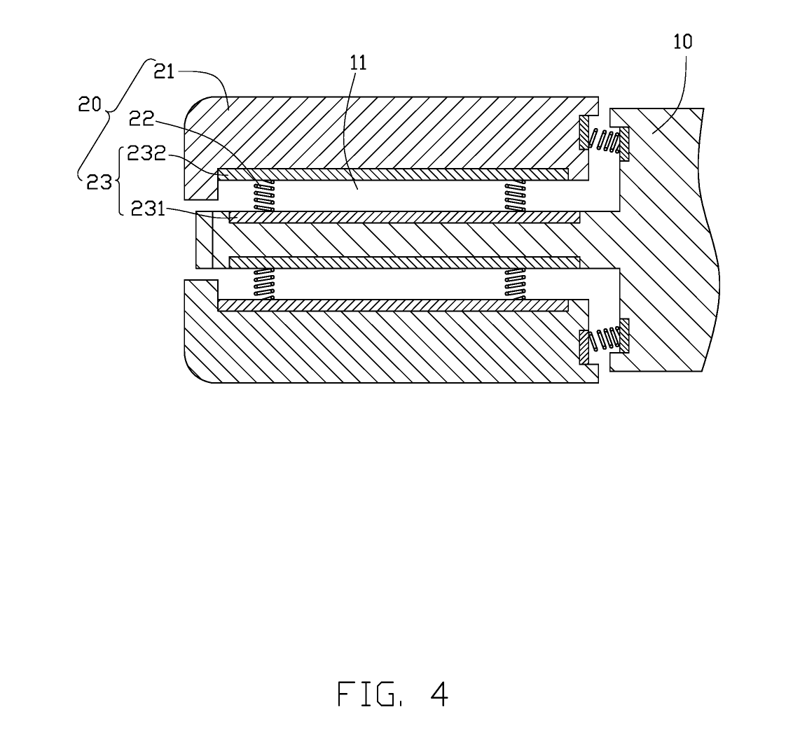

As illustrated in FIG. 4, the controller 40 can obtain the acceleration of the main body 10 from the accelerometer 50. The controller 40 can determine whether the acceleration of the main body 10 is greater than a threshold value. When the acceleration is greater than the threshold value, the controller 40 can control the power supply 30 to stop providing power to the electromagnetic assembly 23, thereby causing the elastic element 22 to decompress and the buffering element 21 to extend away from the main body 10. Thus, when the electronic device 200 is dropped, the buffering element 21 extended away from the main body 10 can cushion impact on the electronic device 200. When the acceleration of the main body 10 is less than the threshold value, the controller 40 controls the power source 30 to continue providing power to the electromagnetic assembly 23.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

1. A protecting apparatus for an electronic device, the protecting apparatus comprising:
a main body fixed to the electronic device and having an outer surface;
at least one buffering assembly arranged on the outer surface of the main body;
an accelerometer arranged within the main body and configured to detect an acceleration of the main body;
a controller arranged within the main body and configured to determine whether the acceleration of the main body exceeds a threshold value;
at least one electromagnetic assembly configured to adhere a corresponding one of the at least one buffering assembly to the main body; and
a power supply arranged within the main body and configured to provide power to the at least one electromagnetic assembly;
wherein the accelerometer, the controller, and the power supply are electrically coupled to each other;
wherein the at least one buffering assembly comprises at least one elastic element and a buffering element;
wherein the at least one buffering element is coupled to the main body through the at least one elastic element;
wherein the electromagnetic assembly comprises a first electromagnetic element arranged on the main body and a second electromagnetic element arranged on the buffering element;
wherein one of the first and second electromagnetic elements is an electromagnet, and the other one of the first and second electromagnetic elements is made of material capable of being attracted by the electromagnet;
wherein in an initial state of the protecting apparatus, the power supply provides power to the electromagnetic assembly to cause the buffering element to adhere to the main body, thereby causing the elastic element to be in a compressed state; and
wherein the controller controls the power supply to stop supplying power to the electromagnetic assembly when the acceleration of the main body exceeds the threshold value, thereby causing the elastic element to decompress and the buffering element to extend away from the main body.

2. The protecting apparatus as in claim 1, wherein the controller controls the power supply to continue to provide power to the at least one electromagnetic assembly when the controller determines that the acceleration of the main body is less than the threshold value.

3. The protecting apparatus as in claim 1, wherein:
the outer surface of the main body defines at least one cutout;
the at least one buffering assembly is received in a corresponding one of the at least one cutout; and
one end of the at least one elastic element is coupled to the main body in the at least one cutout, and another end of the at least one elastic element is coupled to the buffering element.

4. An electronic device comprising:
a main body having an outer surface;
at least one buffering assembly arranged on the outer surface of the main body;
an accelerometer arranged within the main body and configured to detect an acceleration of the main body;
a controller arranged within the main body and configured to determine whether the acceleration of the main body exceeds a threshold value;
at least one electromagnetic assembly configured to adhere a corresponding one of the at least one buffering assembly to the main body; and
a power supply arranged within the main body and configured to provide power to the at least one electromagnetic assembly;
wherein the accelerometer, the controller, and the power supply are electrically coupled to each other;
wherein the buffering assembly comprises at least one elastic element and a buffering element;
wherein the buffering element is coupled to the main body through the at least one elastic element;
wherein the electromagnetic assembly comprises a first electromagnetic element arranged on the main body and a second electromagnetic element arranged on the buffering element;
wherein one of the first and second electromagnetic elements is an electromagnet, and the other one of the first and second electromagnetic elements is made of material capable of being attracted by the electromagnet;
wherein in an initial state of the protecting apparatus, the power supply provides power to the electromagnetic assembly to cause the buffering element to adhere to the main body, thereby causing the elastic element to be in a compressed state; and
wherein the controller controls the power supply to stop supplying power to the at least one electromagnetic assembly when the acceleration of the main body exceeds the threshold value, thereby causing the elastic element to decompress and the buffering element to extend away from the main body.

5. The electronic device as in claim 4, wherein the controller controls the power supply to continue to provide power to the at least one electromagnetic assembly when the controller determines that the acceleration of the main body is less than the threshold value.

6. The electronic device as in claim 4, wherein:
the outer surface of the main body defines at least one cutout;
the at least one buffering assembly is received in a corresponding one of the at least one cutout; and
one end of the at least one elastic element is coupled to the main body in the at least one cutout, and another end of the at least one elastic element is coupled to the buffering element.
